(19) United States
(12) Patent Application Publication
(10) Pub. No.: US 2020/0228988 A1
(43) Pub. Date: Jul. 16, 2020

(54) V2X COMMUNICATION DEVICE AND METHOD FOR INSPECTING FORGERY/FALSIFICATION OF KEY THEREOF

(71) Applicant: LG ELECTRONICS INC., Seoul (KR)

(72) Inventors: Seungryul YANG, Seoul (KR); Jaeho HWANG, Seoul (KR); Woosuk KO, Seoul (KR)

(73) Assignee: LG ELECTRONICS INC., Seoul (KR)

(21) Appl. No.: 16/651,313

(22) PCT Filed: Sep. 29, 2017
(86) PCT No.: PCT/KR2017/011063

§ 371 Date: Mar. 26, 2020

(51) Int. Cl. H04W 12/12; H04L 9/08; H04L 9/32; H04W 4/40

(52) U.S. Cl. CPC H04W 12/12; H04L 9/0869; H04L 2209/80; H04W 4/40; H04L 2209/84; H04L 9/3226

(57) ABSTRACT

Disclosed is a method for inspecting the forgery/falsification of a private key of a V2X communication device. A first PKM random number message including information on an encrypted random number may be received from an external V2X communication device; the encrypted random number may be decrypted using a private key of a V2X communication device; the decrypted random number may be re-encrypted using a public key of the external V2X communication device; a second PKM random number message including information on the re-encrypted random number may be transmitted to the external V2X communication device; and a PKM result message including information on the result of a forgery/falsification inspection of the private key of the V2X communication device may be received from the external V2X communication device.

### TECHNICAL FIELD

The disclosure relates to a device for V2X communication and data communication method, and more particularly, to key forgery/falsification inspection on a V2X communication device.

### BACKGROUND ART

In recent years, a vehicle has become the result of the industrial convergence technology in which an electric technology, an electronic technology, and a communication technology are mixed, rather than the result of mechanical engineering technology. For this reason, the vehicle is also called a smart car. The smart car will provide not only a traditional vehicular technology, such as traffic safety and solving a traffic congestion, but also various user-customized transport services in the future by connecting a driver, a vehicle, a transport infrastructure, etc., one another. Such connectivity may be implemented using a vehicle-to-everything (V2X) communication technology. A system that provides the connectivity of a vehicle may also be referred to as a connected vehicle system.

### DETAILED DESCRIPTION OF THE DISCLOSURE

### Technical Problem

With vehicular connectivity more focused, services for V2X communication increase in amount and kind. V2X communication requires low latency for better message reliability and accuracy. An efficient V2X communication method is demanded due to limited channels.

Meanwhile, vehicle network environments may be subject to hacking or other malicious attacks as are general network environments. Poor security in general networks may cause financial loss but, in vehicle networks, it may put the driver in jeopardy Thus, a need exists for security technology for safe V2X communication.

### Technical Solution

To address the foregoing issues, according to the disclosure, there is proposed a device and method for V2X communication.

According to an embodiment of the disclosure, a method for a modification check on a private key of a V2X communication device comprises receiving a first private key modification (PKM) random number message including information for an encrypted random number from an external V2X communication device, the encrypted random number generated by encrypting a random number generated by the external V2X communication device using a public key of the V2X communication device, decrypting the encrypted random number using the private key of the V2X communication device and reencrypting the decrypted random number using a public key of the external V2X communication device, transmitting a second PKM random number message including information for the reencrypted random number to the external V2X communication device, and receiving a PKM result message including information for a result of the modification check on the private key of the V2X communication device from the external V2X communication device, wherein the modification check result information is generated based on a result of comparison between the random number generated by the external V2X communication device and a random number generated by decrypting the reencrypted random number using a private key of the external V2X communication device.

According to an embodiment, the method may further comprise, before receiving the first PKM random number message, transmitting a PKM initialization message for initializing the modification check on the private key of the V2X communication device to the external V2X communication device, the PKM initialization message including first authentication information for authenticating the V2X communication device, receiving, from the external V2X communication device, a PKM initialization response message responsive to the PKM initialization message, the PKM initialization response message including second authentication information for authenticating the external V2X communication device, and authenticating the external V2X communication device using the second authentication information.

According to an embodiment, the method may further comprise, before receiving the first PKM random number message, receiving, from the external V2X communication device, a PKM request message for requesting the modification check on the private key of the V2X communication device, the PKM request message including second authentication information for authenticating the external V2X communication device, and authenticating the external V2X communication device using the second authentication information.

According to an embodiment, the first authentication information may include first public key information which is information for the public key of the V2X communication device and first signature information which is information for a signature generated using the private key of the V2X communication device, and the second authentication information may include second public key information which is information for the public key of the external V2X communication device and second signature information which is information for a signature generated using the private key of the external V2X communication device.

According to an embodiment, receiving the PKM request message may include periodically receiving the PKM request message from the external communication device.

According to an embodiment, if the V2X communication device fails to transmit the second PKM random number message within a preset period of the reception of the first PKM random number message, a predefined error handling procedure may be performed.

According to an embodiment, the V2X communication device may be a vehicle V2X communication device, and the external V2X communication device may be a road side unit (RSU) V2X communication device.

According to an embodiment of the disclosure, a V2X communication device performing a private key modification check comprises a secure/non-secure storage device storing data, an RF unit transmitting/receiving a wireless signal; and a processor controlling the RF unit, wherein the processor receives a first private key modification (PKM) random number message including information for an encrypted random number from an external V2X communication device, the encrypted random number generated by encrypting a random number generated by the external V2X communication device using a public key of the V2X communication device, decrypts the encrypted random number using the private key of the V2X communication device and reencrypting the decrypted random number using a public key of the external V2X communication device, transmits a second PKM random number message including information for the reencrypted random number to the external V2X communication device, and receives a PKM result message including information for a result of the modification check on the private key of the V2X communication device from the external V2X communication device, wherein the modification check result information is generated based on a result of comparison between the random number generated by the external V2X communication device and a random number generated by decrypting the reencrypted random number using a private key of the external V2X communication device.

### Advantageous Effects

As compared with relying only on the security storage, better security may be achieved by periodically or aperiodically performing forgery/falsification inspection on a vehicle private key.

In operating a private key forgery/falsification procedure, a separate time-out period is set, thereby leading to efficient operation of a network even when more restrictions are imposed on network, such as in a DSRC environment.

The configuration and effects of the disclosure are described below.

### BRIEF DESCRIPTION OF DRAWINGS

FIG. 1 illustrates an intelligent transport system according to an embodiment of the disclosure.

FIG. 2 illustrates a secure communication method of a V2X communication system according to an embodiment of the disclosure.

FIG. 3 illustrates communication between V2X communication devices according to an embodiment of the disclosure.

FIG. 4 illustrates a protocol stack of a V2X communication device according to an embodiment of the disclosure.

FIG. 5 illustrates a procedure for generating a signed message by a V2X communication device according to an embodiment of the disclosure.

FIG. 6 illustrates a V2X communication device for performing forgery/falsification inspection on a private key according to an embodiment of the disclosure.

FIG. 7 illustrates a method for performing forgery/falsification inspection on a private key by a V2X communication device according to an embodiment of the disclosure.

FIG. 8 illustrates a method for verifying private key forgery/falsification by a V2X communication device according to another embodiment of the disclosure.

FIG. 9 illustrates a PKM message for private key forgery/falsification inspection according to an embodiment of the disclosure.

FIG. 10 illustrates a structure of an ITS message including a PKM message according to an embodiment of the disclosure.

FIG. 11 is a flowchart illustrating a key forgery/falsification inspection procedure performed by a vehicle V2X communication device and an RSU V2X communication device according to an embodiment of the disclosure.

FIG. 12 is a flowchart illustrating a key forgery/falsification inspection procedure performed by a vehicle V2X communication device and an RSU V2X communication device according to another embodiment of the disclosure.

FIG. 13 illustrates a V2X communication device according to an embodiment of the disclosure.

FIG. 14 illustrates a method for performing forgery/falsification inspection on a private key by a V2X communication device according to an embodiment of the disclosure.

### MODE FOR CARRYING OUT THE DISCLOSURE

Exemplary embodiments of the disclosure will be described in detail, and examples thereof are illustrated in the accompanying drawings. The detailed description, which will be given below with reference to the accompanying drawings, is intended to explain exemplary embodiments of the disclosure, rather than to show only embodiments that may be implemented according to the disclosure. The following detailed description includes specific details in order to provide a thorough understanding of the disclosure. However, it will be apparent to those skilled in the art that the disclosure may be practiced without such specific details. In the disclosure, respective embodiments described below need not be used separately. Multiple embodiments or all embodiments may be used together and a combination of specific embodiments may be also be used.

Although most terms used in the disclosure have been selected from general ones widely used in the art, some terms have been arbitrarily selected by the applicant and their meanings are explained in detail in the following description as needed. Therefore, the disclosure should be understood based upon the intended meanings of the terms rather than their simple names or meanings.

The disclosure relates to a vehicle-to-everything (V2X) communication device, in which the V2X communication device may be included in an intelligent transport system (ITS) to perform all or part of functions of the ITS. The V2X communication device may perform vehicle-to-vehicle communication, vehicle-to-infrastructure communication, vehicle-to-bicycle communication, vehicle-to-mobile communication, and the like. According to an embodiment, the V2X communication device may be an on board unit (OBU) of a vehicle, or may be included in an OBU. The OBU may also be referred to as an on board equipment (OBE). The V2X communication device may be a roadside unit (RSU) of an infrastructure, or may be included in an RSU. The RSU may also be referred to as roadside equipment (RSE). Alternatively, the V2X communication device may be an ITS station, or may be included in the ITS station. Any OBU, RSU, mobile equipment, or the like that performs V2X communication may be collectively referred to as an ITS station. Alternatively, the V2X communication device may be a wireless access in vehicular environments (WAVE) device, or may be included in the WAVE device. The V2X communication device may also be abbreviated to V2X device.

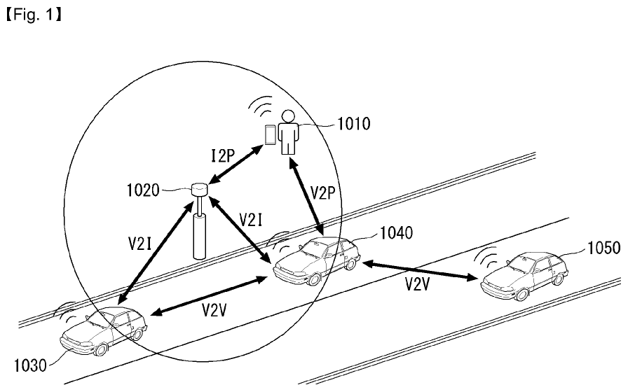

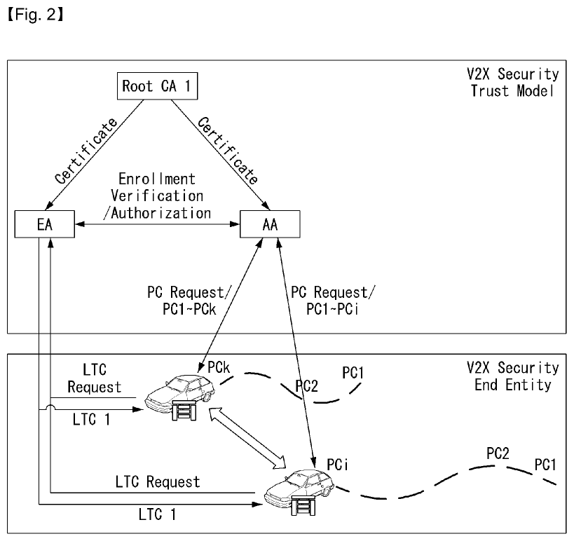

FIG. 1 illustrates a cooperative intelligent transport system (C-ITS) according to an embodiment of the disclosure.

The C-ITS is a system in which an information communication, control, and electronic technology is added to the existing transport system to improve efficiency in transport management and improve user convenience and safety. In the C-ITS, in addition to a vehicle, a transport infrastructure system such as a traffic light and an electronic display also performs V2X communication, and such an infrastructure may also be abbreviated to RSU as described above.

As illustrated in FIG. 1, in the C-ITS, a pedestrian device 1010, an RSU 1020, and vehicles 1030, 1040, and 1050, each of which includes the V2X communication device, perform communication with one another. According to an embodiment, the V2X communication may be performed based on a communication technology of IEEE 802.11p. The communication technology based on IEEE 802.11p may also be referred to as dedicated short-range communication (DSRC). According to an embodiment, the V2X communication based on IEEE 802.11p may be short-range communication within a range of about 600 m. Through the V2X communication, a cooperative awareness message (CAM) or a decentralized environmental notification message (DENM) may be broadcasted.

The CAM is distributed in an ITS network, and provides information regarding at least one of a presence, a location, or a communication state of the ITS station. The DENM provides information regarding a detected event. The DENM may provide information regarding any traveling situation or an event detected by the ITS station. For example, the DENM may provide information regarding a situation such as an emergency electronic brake light, an automobile accident, a vehicle problem, and traffic conditions.

In FIG. 1, the vehicles 1030 and 1040 are present within a communication coverage of the RSU 1020. However, the vehicle 1050 is present outside the communication range of the RSU 1020, and thus may not directly perform communication with the RSU.

FIG. 2 illustrates a secure communication method of a V2X communication system according to an embodiment of the disclosure.

In the embodiment of FIG. 2, the V2X communication system may be a security system required for V2X communication devices (e.g., ITS stations or WAVE devices) to safely transmit/receive messages for V2X communication. Such a V2X communication system may typically use hash, symmetric key algorithm and public key algorithm for security of V2X communication. The public key algorithm may be used to provide confidentiality primarily for data, hash may be used for checking data integrity, and the public key algorithm may be used for public key exchange and electronic signature. In this case, to prove what entity the public key is for, a certificate needs to be issued by a trusted certificate authority (e.g., root CA) and be verifiable/authenticable. Thus, the V2X communication system may use the public key infrastructure (PKI) for safe V2X communication. In other words, the V2X communication system may take advantage of the PKI for trusted message/data communication.

A PKI system normally used may include at least one certificate authority to issue and verify a certificate. For example, as shown in FIG. 2, the PKI system may include a root certificate authority (CA) and/or an enrollment authority (EA), and/or an authorization authority (AA). Each authority is described below.

The root CA may provide the proof that an enrollment credential may be issued to the EA and the AA. The root CA may define authorities and duties for the EA and AA, authenticate the EA and AA, and check whether the EA and AA do their duties. As such, the EA and AA may be controlled by the root AA.

The EA is an entity in charge of lifecycle management of enrollment credentials, and the EA may authenticate the V2X communication device and grant access to V2X communication. The EA may also be referred to as a long-term certificate authority. The EA may issue enrollment certificates (ECs). The V2X communication device may have an EC for authentication on whether the sending V2X communication device is an adequate V2X sending device. The EC may also be denoted a long-term certificate (LTC).

The AA is an entity that issues authorization tickets (ATs) and monitors their use. The AA may provide an authoritative proof for use of a specific V2X service to the V2X communication device. The AA may also be termed a short-term certificate authority or pseudonym certificate authority. The AA may issue ATs. The V2X communication device may have an AT to authenticate a received V2X message (e.g., CAM or DENM). The AT may also be named a short-term certificate or pseudonym certificate (PC).

The V2X communication device may obtain the right to access V2X communication from the EA and negotiate the right to invoke a V2X service from the AA. For example, the V2X communication device may send a request for EC (LCT) to the EA and obtain an EC from the EA. Further, the V2X communication device may send a request for AT (PC) to the AA by use of the EC and obtain an AT from the AA. In this case, the AA may verify/authenticate the validity of the EC via the EA. As such, the V2X communication device may be authenticated for its license by the EA and the AA and participate in the V2X communication network.

Further, the V2X communication device may transmit/receive V2X messages. For example, the V2X communication device may communicate trusted messages with other V2X communication device using the AT. Further, the V2X communication device may transfer the received V2X message to other V2X communication device. In the disclosure, the V2X communication device transmitting the V2X message is denoted a sending V2X communication device, and the V2X communication device receiving the V2X message is denoted a receiving V2X communication device. The V2X communication device forwarding the received V2X communication device to other V2X communication device is denoted a relaying V2X communication device.

A method of communicating trusted messages by the V2X communication devices in the V2X communication system (security system) including the above-described entities is described below in detail with reference to the drawings. Although in the embodiment of FIG. 2, the EC (LTC) and the AT (PC) are issued from separate certificate authorities, embodiments of the disclosure are not limited and, according to an embodiment, the EC (LTC) and the AT (PC) may be issued from the same certificate authority.

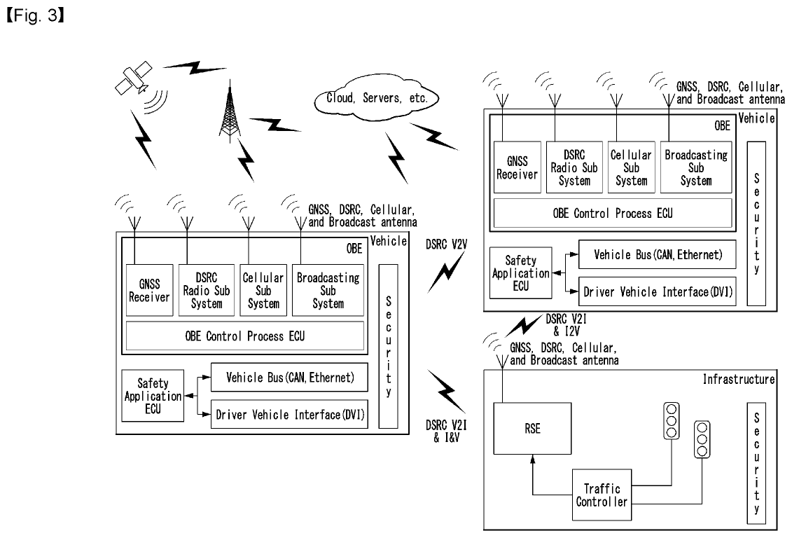

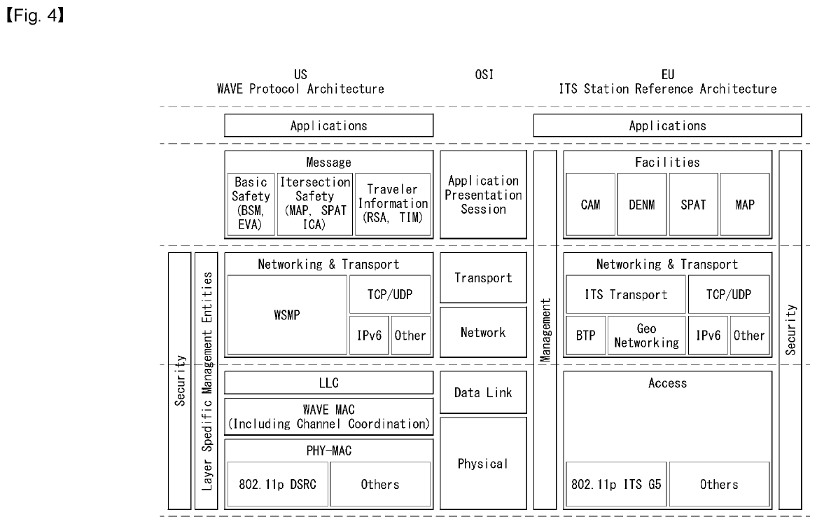

FIG. 3 illustrates communication between V2X communication devices according to an embodiment of the disclosure.

In a connected vehicle system, V2X communication devices mounted in a vehicle, an infrastructure, and a personalized device of a pedestrian may include device components illustrated in FIG. 3, respectively.

A description of components included in a V2X communication device of a vehicle according to an embodiment illustrated in FIG. 3 will be provided below. A V2X communication device of a vehicle may further include an OBE. According to an embodiment, the OBE may include a plurality of antenna systems and an OBE control process electronic control unit (ECU). Antenna system components may be integrated with each other or may be individually provided. Alternatively, a combination of some of the antenna system components may be included.

Global navigation satellite system (GNSS), A satellite navigation system that uses a radio wave transmitted from a satellite to calculate a location, a height, and a speed of a moving object across the earth, which may correspond to an antenna and a subsystem thereof included in a V2X communication device of a vehicle and configured to obtain location information of the vehicle

Dedicated short range communication (DSRC) radio subsystem, An antenna and a subsystem thereof for sending/reception according to a DSRC protocol

Cellular subsystem, An antenna and a subsystem thereof for cellular data communication

Broadcasting subsystem, An antenna and a subsystem thereof for sending/reception of broadcasting data

OBE control process ECU, The OBE control process ECU may be abbreviated to a controller or a processor. The controller may process a data message received from a plurality of heterogeneous systems and control other ECUs in the vehicle to perform appropriate operation. The controller may execute an application for the data processing and vehicle control/operation. Further, the controller may process sensing data received from other electronic equipment or sensors in the vehicle and send the processed sensing data to external V2X communication devices/vehicles. According to an embodiment, all information in the vehicle may be converted into a standardized format that is sharable through the controller. As illustrated in FIG. 3, a safety application may be executed to send and receive information to and from a bus such as a controller area network (CAN) or Ethernet in the vehicle. Further, information may be provided to a user through a driver vehicle interface (DVI) such as a stereo and a display in the vehicle.

The V2X communication device configured as described above may perform communication with an infrastructure, a pedestrian, and a supported system such as a cloud/server, in addition to another vehicle.

A description of components included in a V2X communication device of an infrastructure according to an embodiment illustrated in FIG. 3 will be provided below. A V2X communication device of an infrastructure may include an RSE. Similarly to the OBE of the vehicle, the RSE may include a plurality of antenna systems and a controller (processor). Antenna system components may be integrated with each other or may be individually provided. Alternatively, a combination of some of the antenna system components may be included. Meanwhile, the controller of the RSE may perform operations that are the same as or similar to those of the controller of the OBE. For example, the controller of the RSE may process a data message received from a plurality of heterogeneous systems and control other ECUs in the infrastructure to perform appropriate operation.

The RSE may receive information from a traffic controller to perform communication with a vehicle. The RSE may be a fixed device, and may be backend-connected to be operated as a provider. However, according to an embodiment, the RSE may collect information from a vehicle and send the information again, and thus the RSE may be operated not only as a provider device, but also as a user device.

A description of components included in a V2X communication device of a personalized device (VRU device) of a pedestrian according to an embodiment illustrated in FIG. 3 will be provided below. The V2X communication device of the VRU device may include a plurality of antenna systems and a controller (processor). Antenna system components may be integrated with each other or may be individually provided. Alternatively, a combination of some of the antenna system components may be included. Meanwhile, the controller of the VRU device may perform operations that are the same as or similar to those of the controller of the OBE. For example, the controller of the VRU device may process a data message received from a plurality of heterogeneous systems and control other ECUs in the personalized device to perform appropriate operation. The controller may execute an application for the data processing and control/operation of the personalized device. Further, the controller may process sensing data received from other electronic equipment or sensors in the personalized device and send the processed sensing data to external V2X communication devices. As illustrated in FIG. 3, a safety application may be executed to send and receive information to and from components in the personalized device. Further, information may be provided to a user through a VRU interface such as a stereo and a display in the personalized device.

As illustrated in FIG. 3, communication between vehicles may be referred to as V2V communication, communication between a vehicle and an infrastructure may be referred to as V2I communication or I2V communication, and communication between a vehicle and a personalized device of a pedestrian may be referred to as V2P communication or P2V communication. As illustrated in FIG. 3, communication between vehicles using DSRC may be referred to as DSRC V2V communication, communication between a vehicle and an infrastructure using DSRC may be referred to as DSRC V2I communication or DSRC I2V communication, and communication between a vehicle and a personalized device of a pedestrian using DSRC may be referred to as DSRC V2P communication or DSRC P2V communication. Meanwhile, communication between a vehicle and another V2X communication device may be collectively referred to as V2X communication, and communication between a V2X communication device and another V2X communication device may be collectively referred to as X2X communication.

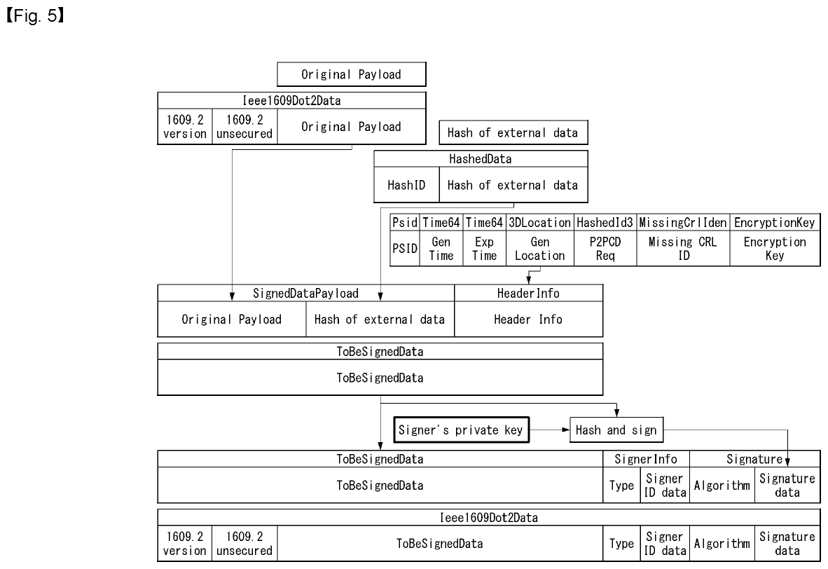

FIG. 4 illustrates a protocol stack of a V2X communication device according to an embodiment of the disclosure. Specifically, FIG. 4 illustrates a protocol stack of a V2X communication device of United States (US) or Europe (EU) according to an embodiment of the disclosure.

The V2X communication devices illustrated in FIG. 3 may perform communication with one another by using a communication protocol for V2X communication illustrated in FIG. 4.

Description of respective layers illustrated in FIG. 4 is provided below.

Applications layer, The applications layer may implement and support various use cases. For example, an application may provide information regarding road safety, efficient traffic information, information regarding other applications.

Facilities layer, The facilities layer is a layer corresponding to open systems interconnection (OSI) layer 5 (session layer), OSI layer 6 (presentation layer), and OSI layer 7 (application layer). The facilities layer may support effective implementation of various use cases defined in the applications layer. For example, the facilities layer may provide an application programming interface (API) for encoding/decoding a message for supporting an application. According to an embodiment, the message may be encoded/decoded in abstract syntax notation one (ASN.1).

A service and a message set provided in the facilities layer is defined by the Society of Automotive Engineers (SAE) in U.S., and is defined by Intelligent Transport Systems (ITS) of European Telecommunications Standards Institute in Europe. For example, a basic safety message (BSM) for supporting a basic safety application, an emergency vehicle alert (EVA) message, a MAP (mapdata) message for supporting an intersection safety application, a signal phase and timing (SPAT) message, an intersection collision alert (ICA) message, a roadside alert (RSA) message for supporting a traveler information application, a traveler information message (TIM), and the like may be provided as the message set in U.S. A cooperative awareness message (CAM), a decentralized environmental notification message (DENM), and the like may be provided as the message set in Europe.

Networking/transport layer, The networking/transport layer is a layer corresponding to OSI layer 3 (network layer) and OSI layer 4 (transport layer). The networking/transport layer may configure a network for vehicle communication between homogenous/heterogeneous networks by using various transport protocols and network protocols. For example, the networking/transport layer may provide Internet access and routing using the Internet protocol such as TCP/UDP+IPv6. Alternatively, the networking/transport layer may configure a vehicle network by using a geographical-position-based protocol such as basic transport protocol (BTP)/GeoNetworking. Alternatively, the networking/transport layer may configure a vehicle network by using a WAVE short message protocol (WSMP) (e.g., WSMP-N and WSMP-T).

Further, the networking/transport layer may provide an advertisement of provided services. For example, such an advertisement may be provided through WAVE service advertisement (WSA) in U.S., and may be provided through a service announcement message (SAM) in Europe.

Access layer, The access layer is a layer corresponding to OSI layer 1 (physical layer) and OSI layer 2 (data link layer). The access layer may send, on a physical channel, a message/data received from a higher layer. For example, the access layer may perform/support data communication based on at least one of a communication technology based on IEEE 802.11 and/or 802.11p standard, a WIFI physical transmission technology based on IEEE 802.11 and/or 802.11p standard, a DSRC technology, a 2G/3G/4G (LTE)/5G wireless cellular communication technology including satellite/broadband wireless mobile communication, a global positioning system (GPS) technology, Bluetooth, or a WAVE technology based on IEEE 1609. Meanwhile, in U.S., a medium access control (MAC) technology based on IEEE 1609.4 standard is complemented and used to support communication in a vehicle environment.

Security layer, The security layer is a layer for data trust and privacy. The security layer may provide an authentication function and an encryption function for assuring privacy. The authentication is used to indicate whether or not a sender is a certified V2X communication device and whether or not data are changed, and the encryption is used to keep secrets in data. According to an embodiment, the message or data generated in the networking/transport layer may be sent after being secured through the security layer according to a type of the message or data, or may be sent in a non-secured state.

Management layer, The management layer may provide multi-channel decentralized congestion control (MDCC). Further, the management layer may generate contents for a service advertisement based on information received from a higher layer, and the contents may include IP configuration information and security credential information. Further, the management layer may monitor the received service advertisement and estimate a channel quality to determine a channel allocation/switching schedule.

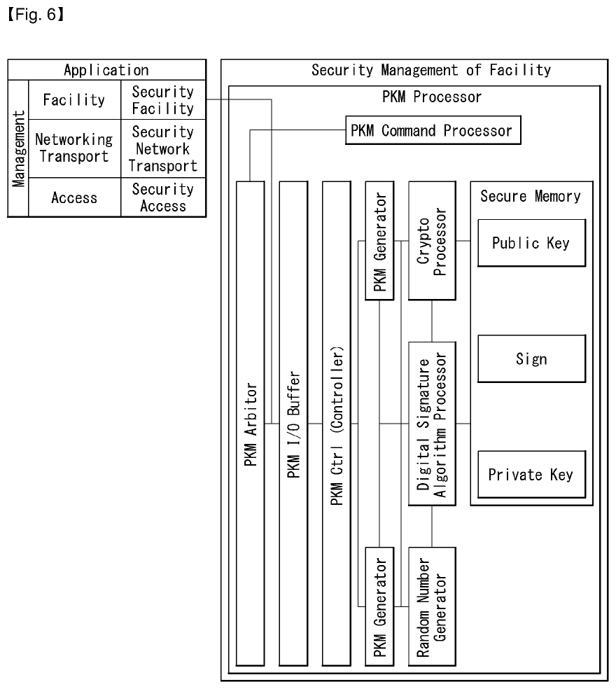

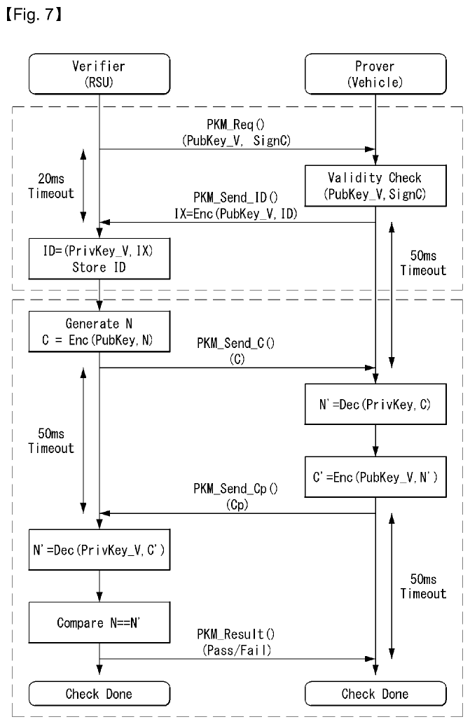

FIG. 5 illustrates a procedure for generating a signed message by a V2X communication device according to an embodiment of the disclosure. In the embodiment of FIG. 5, the V2X communication device may be a V2X communication device (e.g., a WAVE device) that complies with the U.S. protocol (WAVE protocol).

As shown in FIG. 5, to generate a signed message, the V2X communication device (e.g., a vehicle V2X communication device) may use a private key. For example, the V2X communication device may perform an elliptic curve crypto (ECC) operation on a value resulting from hashing the “TobesignedDate” using the signer's private key at the time that the message is signed. The so-generated resultant value (signed value) may be added to the tail of the message that is then transmitted. The signed value may be used to prove the right of the message sender.

As such, the private key includes secret information used upon digital signature of the V2X message. The private key may be used when authentication or decoding is needed.

If the private key is forged or falsified, impersonation with the right to the message or other security issues may arise. As such, if an integrity issue occurs with the private key, messages signed with the private key may be communicated, thus harming the security for the PKI system. Thus, it is of significance in the PKI system to manage the private key. In other words, since the security of private key may guarantee the stability of system in the PKI system, management of the private key is of the utmost importance.

For the purpose of private key security, some standard documents (e.g., ETSI ITS TR 10 893 Threat, Vulnerability and Risk Analysis (TVRA)) that specify the security of V2X communication require that information for the private key be stored in secure memory. However, nowhere do the published technology and documents disclose a specific way to store such private key in secure memory and techniques to securely manage the private key.

Meanwhile, vehicular communication environments are subjected to various restrictions for stability purposes, unlike other communication environments. Thus, password-based private key management as in the Internet environment may be impracticable. For example, for safety purposes, drivers may not be forced to enter their password for private key authentication while driving. Hence, a new approach is required for private key security that fits for the vehicular environment. In particular, a scheme for identifying whether the private key has been forged or falsified needs to be taken into consideration.

Methods for ensuring the security of private key used for V2X secure communication is described below with reference to the drawings. Among others, a method for identifying whether the private key has been forged/falsified is described.

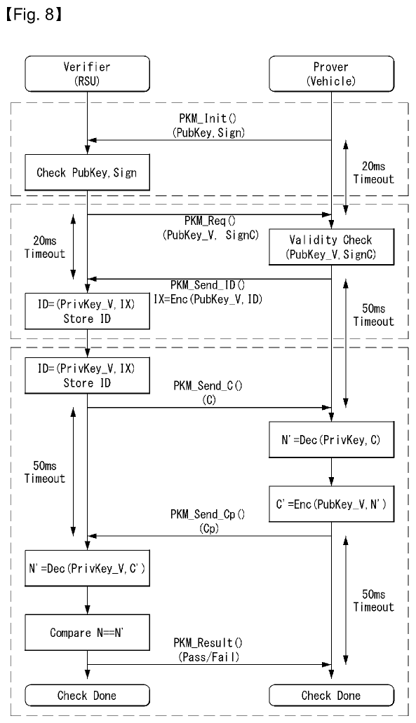

FIG. 6 illustrates a V2X communication device for performing forgery/falsification inspection on a private key according to an embodiment of the disclosure. In the embodiment of FIG. 6, a private key modification check may be a service that is offered by a facility layer. The V2X communication device may perform private a key modification check using a predefined private key modification check protocol. In the disclosure, the private key modification check protocol may be simply referred to as a modification check.

According to an embodiment, the predefined private key modification check protocol may be a verification protocol using a random number. In a case where a random number-based private key modification check protocol is put to use, if the prover has not forged/falsified the private key, a random number generated by the verifier and sent to the prover will, after processed by the prover, be returned as the same value. However, if the prover has forged/falsified the private key, a random number generated by the verifier and sent to the prover will not, after processed by the prover, be returned as the same value. This is described below in greater detail with reference to the drawings.

Referring to FIG. 6, to verify whether the private key is forged/falsified, the V2X communication device may include a security management entity associated with the facility layer. The security management entity is a management entity of facility level and may perform processing and management on security messages.

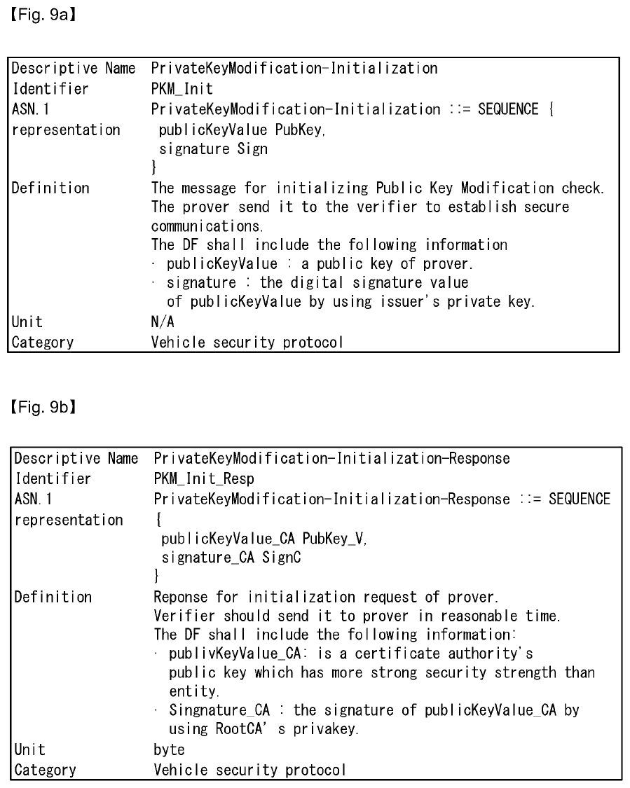

The security management entity may include at least one processor. For example, the security management entity may include a private key modification (PKM) processor. The PKM processor is a processor for transmission/reception of PKM messages. According to an embodiment, the PKM processor may include a PKM command processor, a PKM arbiter, a PKM I/O buffer, a PKM controller, a PKM generator, a PKM parser, a crypto processor, a digital signature algorithm processor, a random number generator, and/or a secure memory. Meanwhile, the components of the PKM processor of FIG. 7 may be integrated together or provided separately, or some of them may be combined together. Each component included in the security management entity or PKM processor is described below.

PKM command processor: a module (processor) that identifies a message received from the PKM arbiter and requests a necessary device to process the same.

PKM arbiter: a module (arbiter) for managing transmission/reception commands among application commands. The PKM arbiter may analyze commands and the process and transfer the analyzed commands to the PKM command processor.

PKM I/O buffer: a message transmission/reception buffer for transmission/reception and processing of PKM messages.

PKM controller: a controller for managing the state of each component/module and controlling them. If a certain module has an issue, the PKM controller may recover using a timeout function.

PKM generator: a module that generates PKM messages for transmission.

PKM parser: a module that parses received PKM messages.

Crypto processor: a module for encryption/decryption processing of the modification check protocol.

Digital signature algorithm processor: a module that performs authentication and signature processing on the public key.

Random number generator: a module for generating a random number used in the modification check protocol.

Secure memory: a module for storing/managing confidential data. The secure memory may include the public key, private key, and/or signature.

Public key: a public key for use in encryption.

Private key: a private key of the V2X communication device for decryption. In the disclosure, the private key includes information that is subject to a modification check.

Signature (sign): a signature on the public key by a higher authority.

The specific configuration of the V2X communication device of FIG. 6 may be implemented so that various embodiments of the disclosure are applied independently from each other or two or more thereof are applied together.

FIG. 7 illustrates a method for performing forgery/falsification inspection on a private key by a V2X communication device according to an embodiment of the disclosure.

In the embodiment of FIG. 7, the V2X communication device of the RSU (RSU V2X communication device) may play a role as the verifier, and the V2X communication device of the vehicle (vehicle V2X communication device) may play a role as the prover. Here, the verifier means an entity that identifies forgery/falsification of the private key, and the prover means an entity that proves that its private key has no issue.

Meanwhile, it is assumed in the embodiment of FIG. 7 that a modification check method/procedure is initiated at the request of the verifier. It is also assumed in the embodiment of FIG. 7 that the prover's public key (PubKey), signature (Sign), and/or private key (PubKey) are information previously shared with the verifier.

Referring to FIG. 7, the modification check procedure may include a device authentication step (authentication step) and a private key modification check step.

First, the authentication step may identify whether the verifier is a valid verifier. That is, the verifier may be authenticated. The authentication step may authenticate the verifier by performing a validity check on authentication information for authenticating the verifier.

For example, if the verifier is not qualified, a modification check need not be performed on the prover's private key. Thus, the verifier need be authenticated via the authentication step prior to the private key modification check step. The authentication step is described below in detail.

In the authentication step, the verifier may transmit a PKM request message (PKM_Req) for requesting a modification check on the prover's private key to the prover. According to an embodiment, the PKM request message may include authentication information used for authenticating the prover or proving her qualification. According to an embodiment, the verifier's authentication information may include information related to the verifier's public key. For example, the authentication information may include information for the verifier's public key (PubKey_V) and/or signature (SignC). At this time, the signature (SignC) may be one generated using the verifier's private key (PrivKey_V).

By the authentication information, the prover may identify whether the verifier is able to verify herself, i.e., whether the verifier is a valid one. In other words, the prover may authenticate/identify whether the verifier has credentials by which she may verify herself based on the verifier information in the first PKM request message. The verifier's authentication information may be denoted verifier information or verifier credential information.

The prover may parse the PKM request message and check the validity of the authentication information using a preset validity check method/algorithm. For example, the prover may digital signature-verify the validity of the authentication information, (PubKey_V, SignC), using a known digital signature algorithm.

Further, the prover may transmit a message responsive to the PKM request message to the verifier. For example, if the authentication information is invalid (i.e., if the verifier is not authenticated), the prover may transmit a PKM error message (PKM_Req_Err), as the response message, to the verifier. If the authentication information is valid (i.e., if the verifier is authenticated), the prover may encrypt the prover's ID with the verifier's public key (PubKey_V) and transmit a PKM ID message (PKM_Send_ID) containing information for the encrypted prover ID (IX), as the response message, to the verifier.

The verifier may parse the message responsive to the PKM request message. For example, the verifier may parse the PKM ID message and obtain the information for the encrypted prover ID (IX). In this case, the verifier may obtain the prover's ID by decrypting the encrypted prover ID (IX) using the verifier's private key (PrivKey_V). By the above-described authentication step, the verifier may prove that she is a valid verifier and obtain the prover's ID. Further, the prover may identify that the verifier is a valid verifier. Thereafter, the verifier and the prover may perform the private key modification check step.

Meanwhile, if the verifier fails to receive a message responsive to the PKM request message within a preset period (e.g., 20 ms) of the transmission of the PKM request message, the authentication step or modification check procedure may be terminated. As such, setting a timeout period enables the network to be efficiently operated even when many restrictions are imposed on the network as in the DSRC environment. The private key modification check step is described below in greater detail.

In the private key modification check step, the verifier may generate a random number (N) and encrypt the random number with the prover's public key (PubKey). As set forth above, since the prover's public key is pre-shared information, the verifier may encrypt the random number with the public key. By so doing, the verifier may obtain information for first encrypted random number (C). The verifier may transmit a first PKM random number message (PKM_Send_C) including the first encrypted random number information to the prover.

Meanwhile, according to an embodiment, if the verifier fails to transmit the first PKM random number message within a preset period (e.g., 50 ms) of the reception of the PKM ID message, the private key modification check step or modification check procedure may be terminated. As such, setting a timeout period enables the network to be efficiently operated even when many restrictions are imposed on the network as in the DSRC environment.

The prover may parse the first PKM random number message. For example, the verifier may parse the first PKM random number message and obtain information for the first encrypted random number (C). In this case, the prover may decrypt the first encrypted random number using the prover's private key (PrivKey). By so doing, the prover may obtain information for the decrypted random number (N′). Thereafter, the prover may reencrypt the decrypted random number using the verifier's public key (PubKey_V). Thus, the prover may obtain information for the reencrypted random number (C′).

The prover may transmit a message responsive to the first PKM random number message to the verifier. For example, the prover may transmit a second PKM random number message (PKM_Send_Cp) including information for the reencrypted random number (C′ or Cp), as the response message, to the verifier.

Meanwhile, according to an embodiment, if the prover fails to transmit the second PKM random number message within a preset period (e.g., 50 ms) of the reception of the first PKM random number message, the private key modification check step or modification check procedure may be terminated. As such, setting a timeout period enables the network to be efficiently operated even when many restrictions are imposed on the network as in the DSRC environment.

The verifier may parse the second PKM random number message. For example, the verifier may parse the second PKM random number message and obtain information for the reencrypted random number (C′). In this case, the verifier may decrypt the reencrypted random number using the verifier's private key (PrivKey_V). By so doing, the verifier may obtain information for the decrypted random number (N′). Since the value resulting from decrypting the encrypted random number (C) has been decrypted with a pair of the verifier's public key and private key which have not been forged/falsified, the value resulting from decrypting the reencrypted random number (C′) is the same as the value resulting from decrypting the encrypted random number (C).

Thereafter, the verifier may determine whether the prover's private key has been forged/falsified by making comparison as to whether the decrypted random number (N′) is the same as the first random number (N) generated by the verifier. For example, if the decrypted random number (N′) is identical to the first generated random number (N), the verifier may determine that the prover's private key has not been forged/falsified. Or, unless the decrypted random number (N′) is identical to the first generated random number (N), the verifier may determine that the prover's private key has been forged/falsified.

Then, the verifier may transmit a PKM result message including the result information for the modification check on the prover's private key to the prover. For example, if the prover's private key is determined not to have been forged/falsified, the verifier may transmit a PKM result message including pass information indicating that the prover's private key has not been forged/falsified to the prover. Or, if the prover's private key is determined to have been forged/falsified, the verifier may transmit a PKM result message including fail information indicating that the prover's private key has been forged/falsified to the prover.

The prover may parse the PKM result message and perform a preset operation depending on the message included in the PKM result message. For example, upon receipt of the PKM result message including the pass message, the prover may perform encryption communication. Or, when receiving the PKM result message including the fail message, the prover may perform a procedure for regenerating and enrolling her private key/public key.

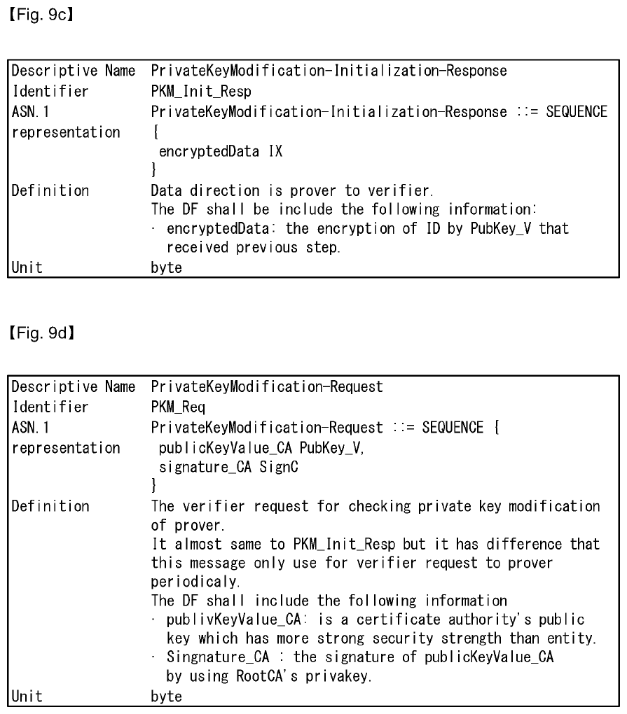

FIG. 8 illustrates a method for verifying private key forgery/falsification by a V2X communication device according to another embodiment of the disclosure. Substantially the same descriptions as those given above in connection with FIG. 7 are omitted from description of the embodiment of FIG. 8.

Like in the embodiment of FIG. 7, in the embodiment of FIG. 8, the V2X communication device of the RSU (RSU V2X communication device) may play a role as the verifier, and the V2X communication device of the vehicle (vehicle V2X communication device) may play a role as the prover.

Meanwhile, it is assumed in the embodiment of FIG. 8 that a modification check method/procedure is initiated at the request of the prover. It is also assumed in the embodiment of FIG. 8 that the prover's public key (PubKey), signature (Sign), and/or private key (PubKey) are information previously shared with the verifier.

Referring to FIG. 8, the modification check procedure may include an initialization step, an authentication step, and a private key modification check step. Since substantially the same or similar descriptions as those given in connection with FIG. 7 may apply to the authentication step and the private key modification check step, the following description focuses primarily on the initialization step. The initialization step and the authentication step may be collectively referred to as a mutual authentication step.

For example, if the prover first attends the vehicle network, the prover may send a request for a modification check procedure to the verifier via the initialization step. In the initialization step, the prover may transmit a PKM initialization request message (PKM_Init) for initializing a private key modification check to the verifier. According to an embodiment, the PKM initialization request message may include authentication information used for validity check on the prover's public key or for the prover authentication/credential purposes. According to an embodiment, the prover's authentication information may include the prover's public key-related information. For example, the authentication information may include information for the prover's public key (PubKey) and/or signature (Sign). At this time, the signature (Sign) may be one generated using the prover's private key (PrivKey).

By way of the prover's authentication information, the verifier may identify whether the prover has a valid qualification or whether the prover's public key is valid. The prover's authentication information may be denoted prover information or prover credential information.

The verifier may parse the PKM initialization request message and check the validity of the prover's authentication information using a preset validity check method/algorithm. Thus, the verifier may identify whether the prover is a due prover or whether the prover's public key is valid.

Further, the verifier may transmit a message responsive to the PKM initialization message to the prover. For example, if the prover's authentication information is invalid (i.e., if the prover's public key is invalid), the verifier may transmit a PKM error message (PKM_Init Err), as the PKM initialization response message, to the prover. Or, if the prover's authentication information is valid (i.e., if the prover's public key is valid), the verifier may transmit a PKM initialization response message including the verifier's authentication information to the prover. At this time, the verifier's authentication information is the same as what has been described above in connection with FIG. 8. Thereafter, the verifier and prover may perform the authentication procedure and modification check procedure described above in connection with FIG. 8. This is briefly described below.

For example, the prover may parse the PKM initialization response message and check the validity of the authentication information using a preset validity check method/algorithm. For example, the prover may digital signature-verify the validity of the authentication information, (PubKey_V, SignC), using a known digital signature algorithm.

If the authentication information is invalid (i.e., if the verifier is not authenticated), the prover may transmit a PKM error message (PKM_Req_Err) to the verifier. If the authentication information is valid (i.e., if the verifier is authenticated), the prover may encrypt the prover's ID with the verifier's public key (PubKey_V) and transmit a PKM ID message (PKM_Send_ID) containing information for the encrypted prover ID (IX) to the verifier.

The verifier may parse the PKM ID message and obtain the information for the encrypted prover ID (IX). In this case, the verifier may obtain the prover's ID by decrypting the encrypted prover ID (IX) using the verifier's private key (PrivKey_V).

Meanwhile, if the verifier fails to receive a message responsive to the PKM request message within a preset period (e.g., 20 ms) of the transmission of the PKM request message, the authentication step or modification check procedure may be terminated. As such, setting a timeout period enables the network to be efficiently operated even when many restrictions are imposed on the network as in the DSRC environment. The private key modification check step is described below in greater detail.

Further, the verifier may generate a random number (N) and encrypt the random number with the prover's public key (PubKey). By so doing, the verifier may obtain information for first encrypted random number (C). The verifier may transmit a first PKM random number message (PKM_Send_C) including the first encrypted random number information to the prover.

Meanwhile, according to an embodiment, if the verifier fails to transmit the first PKM random number message within a preset period (e.g., 50 ms) of the reception of the PKM ID message, the private key modification check step or modification check procedure may be terminated.

The verifier may parse the first PKM random number message and obtain information for the first encrypted random number (C). In this case, the prover may decrypt the first encrypted random number using the prover's private key (PrivKey). By so doing, the prover may obtain information for the decrypted random number (N′). Thereafter, the prover may reencrypt the decrypted random number using the verifier's public key (PubKey_V). Thus, the prover may obtain information for the reencrypted random number (C′).

The prover may transmit a second PKM random number message (PKM_Send_Cp) including information for the reencrypted random number (C′ or Cp), as the response message, to the verifier.

Meanwhile, according to an embodiment, if the prover fails to transmit the second PKM random number message within a preset period (e.g., 50 ms) of the reception of the first PKM random number message, the private key modification check step or modification check procedure may be terminated.

The verifier may parse the second PKM random number message and obtain information for the reencrypted random number (C′). In this case, the verifier may decrypt the reencrypted random number using the verifier's private key (PrivKey_V). By so doing, the verifier may obtain information for the decrypted random number (N′).

Thereafter, the verifier may determine whether the prover's private key has been forged/falsified by making comparison as to whether the decrypted random number (N′) is the same as the first random number (N) generated by the verifier. The verifier may transmit a PKM result message including the result information for the modification check on the prover's private key to the prover. The prover may parse the PKM result message and perform a preset operation depending on the message included in the PKM result message.

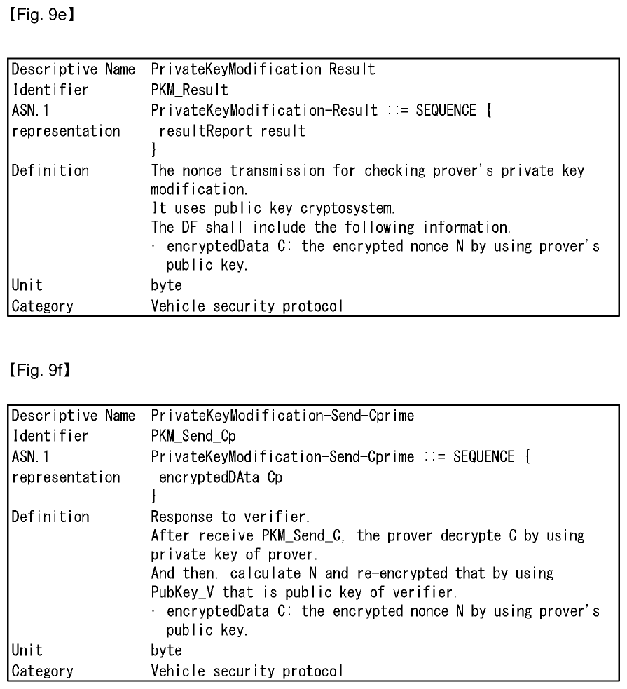

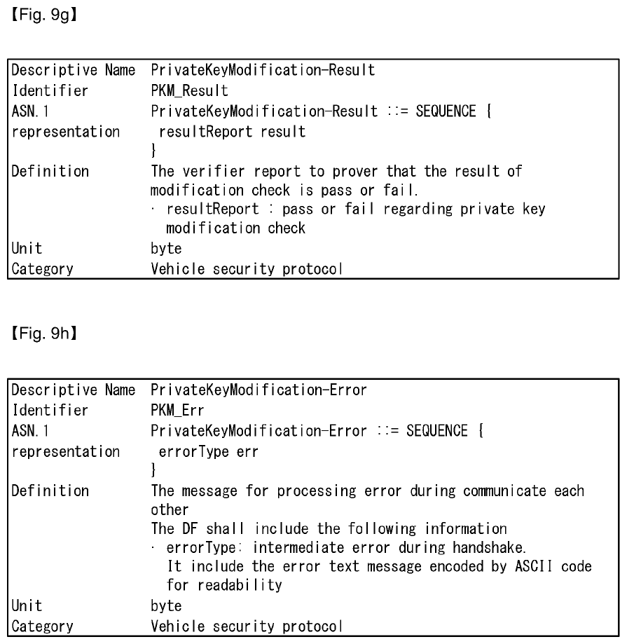

FIG. 9 illustrates a PKM message for private key forgery/falsification inspection according to an embodiment of the disclosure. In the embodiment of FIG. 9, the PKM message may be a PKM message used in the private key modification check procedure of FIGS. 7 and 8.

In the embodiment of FIG. 9(a), a PKM initialization message (PKM_Init) is shown to initialize the private key modification check. The PKM initialization message may be denoted a PKM initialization request message. The PKM initialization message may be used when the modification check procedure is initiated by the prover.

As described above in connection with FIG. 8, the PKM initialization message may be used for the prover to request the verifier to initialize or initiate the modification check. The prover may transmit the PKM initialization message to establish secure communication.

According to an embodiment, the PKM message may include public key information (publicKeyValue) indicating the prover's public key value and/or signature information indicating the digital signature value of the public key information using the issuer's private key, as a data frame (DF). In this case, the PKM message may be used for the prover to transfer her public key (PubKey) and signature (sign) thereon to the verifier. The public key information may be denoted the prover's public key information or first public key information, and the signature information may be denoted the prover's signature information or first signature information.

In the embodiment of FIG. 9(b), a PKM initialization response message (PKM_Init_Resp) which is responsive to the PKM initialization message is shown.

As described above in connection with FIG. 8, the PKM initialization response message may be used to respond to the prover's initialization request via the PKM initialization message. The prover needs to the PKM initialization response message within a preset period.

According to an embodiment, the PKM initialization response message may include CA public key information (publivKeyValue_CA) indicating the public key value of the CA with a higher security strength than the entity and CA signature information (Signature_CA) indicating the signature value of the CA public key information using the private key of the root CA, as a DF. In this case, the PKM initialization response message may be used for the prover to transfer her public key (PubKey_V) and a signature (SignC) thereon. The PKM initialization response message may be stored in the verifier's specific space and managed regardless of the reception of the PKM initialization message.

The CA public key information may be denoted the verifier's public key information or second public key information, and the signature information may be denoted the verifier's signature information or second signature information.

In the embodiment of FIG. 9(c), a PKM ID message (PKM_Send_ID) for the prover to transfer/transmit her ID information to the verifier is shown.

As described above in connection with FIGS. 7 and 8, the prover may use the PKM ID message to encrypt her ID with the verifier's public key (PubKey_V) obtained via the PKM initialization response message (PKM_Init_Resp) or the first PKM request message (PKM_V_SignC) and to transfer information for the encrypted prover ID (IX) to the verifier.

According to an embodiment, the PKM ID message may include, as a DF, encryption information/data which is information/data for the prover ID, which has been encrypted with the verifier's public key received in the previous step.

In the embodiment of FIG. 9(d), a PKM request message (PKM_Req) for the verifier to request a modification check on the prover's private key is shown. The PKM request message may be denoted a first PKM request message. The PKM request message may be used when the modification check procedure is initiated by the verifier.

The PKM request message has substantially the same features as those of the PKM initialization request message except for being used for the verifier to periodically request the prover to perform a private key modification check.

As described above in connection with FIG. 7, in order for the verifier to periodically identify the prover's private key, the verifier may transmit a PKM request message including her public key information (PubKey_V) and signature information (SignC).

According to an embodiment, the PKM request message may include CA public key information (publivKeyValue_CA) indicating the public key value of the CA with a higher security strength than the entity and CA signature information (Signature_CA) indicating the signature value of the CA public key information using the private key of the root CA, as a DF.

In the embodiment of FIG. 9(e), a PKM random number message (PKM_Send_C) for the verifier to transmit a random number (nounce) for checking the prover's private key is shown. As such, the PKM random number message transmitted by the verifier may be denoted a first PKM random number message or second PKM request message.

According to an embodiment, the PKM random number message may include, as a DF, information (encryptedData_C) for a random number (a first encrypted random number) encrypted with the prover's public key. At this time, a public key encryption system may be used.

As described above in connection with FIG. 7, the verifier may transmit the PKM random number message including the information for the first encrypted random number so as to check whether the prover's private key has been forged/falsified.

In the embodiment of FIG. 9(f), a PKM random number response message (PKM_Send_Cp) which is responsive to the PKM random number message is shown. As such, the PKM random number response message transmitted by the prover may be denoted a second PKM random number message or second PKM response message.

According to an embodiment, the PKM random number response message may include, as a DF, information (encryptedData_Cp) for a random number (a second encrypted random number) encrypted with the verifier's public key. At this time, a public key encryption system may be used.

As described above in connection with FIG. 7, upon receiving the PKM random number message, the prover may decrypt the first encrypted random number with the prover's private key. The prover may reencrypt the decrypted random number using the verifier's public key (PubKey_V) and include information therefor in the PKM random number response message.

In the embodiment of FIG. 9(g), a PKM result message (PKM Result) for reporting the result of private key modification check is shown.

According to an embodiment, the PKM result message may include, as a DF, result report information (resultReport) indicating whether the private key modification check has been passed or failed. According to an embodiment, the result report information may include pass information indicating that the private key modification check has been passed, i.e., indicating that the prover's private key has not been forged/falsified or fail information indicating that the private key modification check has been failed, i.e., indicating that the prover's private key has been forged/falsified.

As described above in connection with FIG. 7, upon receiving the PKM random number response message, the verifier may parse the PKM random number response message and obtain the information for the second encrypted random number (C′). The verifier may decrypt the second encrypted random number using the verifier's public key (PrivKey_V) and obtain the information for the decrypted random number (N′). The verifier may determine whether the prover's private key has been forged/falsified by making comparison as to whether the decrypted random number (N′) is the same as the first random number (N) generated by the verifier. The verifier may transmit the PKM result message to the prover. Thereafter, the prover may parse the PKM result message and perform a preset operation depending on the message included in the PKM result message.

In the embodiment of FIG. 9(h), a PKM error message (PKM Error) for processing an error caused while the verifier and the prover communicate with each other is shown.

According to an embodiment, the PKM error message may include, as a DF, error type information indicating the type of an intermediate error that occurs during communication or handshake. The error type information may include error text encoded with, e.g., a readable ascii code.

As described above in connection with FIG. 7, the PKM error message may be a message used to indicate an error that occurs during the private key modification check procedure and may be used by both the verifier and the prover. For example, if forgery/falsification of the private key is identified or a preset timeout period elapses during the private key modification check procedure, the verifier or prover may notify the other party of the error type using the PKM error message. Upon reception of the PKM error message, the verifier or prover may perform operations accordingly. As such, the PKM error message allows the verifier and prover to identify which step the error has occurred in.

Table 1 below shows PKM error types (error types) according to an embodiment of the disclosure.

TABLE 1

| PKM Error Type | Detail |
|---|---|
| PKM_Init_Err | data validity-related error transferred in |
| | PKM_Init |
| PKM_Init_Resp_Err | data validity-related error for PKM_Init_Resp |
| PKM_Req_Err | data validity-related error for PKM_Req |

Referring to Table 1, the error types may include a first error type (PKM_Init Err) indicating the data validity check error transferred in the PKM_Init, a second error type (PKM_Init_Resp Err) indicating the data validity check error for PKM_Init_Resp, and/or a third error type (PKM_Req_Err) indicating the data validity check error for the PKM_Req.

The first error type (PKM_Init Err) may occur when the data validity transferred in the PKM_Init has a problem, the second error type (PKM_Init_Resp Err) may occur when the data validity for PKM_Init_Resp has a problem, and the third error type (PKM_Req_Err) may occur when the data validity for PKM_Req has a problem.

Meanwhile, an embodiment of transmission/reception of radio signals including PKM messages using the configuration of FIG. 7 and the PKM message structure of FIG. 9 is described below.

First, a PKM message transmission procedure is described, with the PKM initialization message taken as an example. If a function is invoked from the application layer for transmission of a PKM message, the PKM command processor may receive information for generating a PKM message from the application layer and generate a PKM message. For example, to obtain information for the prover's public key and signature included in the PKM initialization message (PKIK_Init), the PKM command processor may request the PKM generator, and the PKM generator may read the public key and signature in the secure storage. The PKM generator may generate a header and add information for the public key and signature to the payload, thereby generating a PKM initialization message.

The PKM controller may store the generated PKM message in the PKM I/O buffer. The PKM arbiter may identify the header indicator of the PKM message stored in the buffer and request the PKM command processor to send the PKM message. Upon receiving the request for transmitting the PKM message, the PKM command processor may transfer the PKM message to a lower layer. The so-transferred PKM message may be transmitted to the external V2X communication device via a radio signal generated via processing by the lower layer (e.g., networking/transport layer or access layer).

Next, an example PKM message reception procedure is described. Upon reception of the PKM message-containing radio signal, the PKM message may be transferred to the facility layer via processing by the lower layer (e.g., the access layer or networking/transport layer). The so-transferred PKM message may be stored in the PKM I/O buffer. The PKM arbiter may identify the header of the PKM message, identifying that the PKM message is the reception message. To identify the PKM message, the PKM arbiter may request the PKM command processor to process the message, and the PKM command processor may allow the PKM parser to parse the PKM message. The PKM parser may parse the PKM message. If the PKM message has been encrypted, the PKM message may be transferred to the encryption processor and be decrypted by the encryption processor. Thereafter, depending on the type of the PKM message, the digital signature algorithm processor may be used, and processing may be performed on the private key to identify whether the prover's private key has been forged/falsified. The result of processing may be transferred to the PKM command processor and the application layer may be allowed to be aware of success or failure.

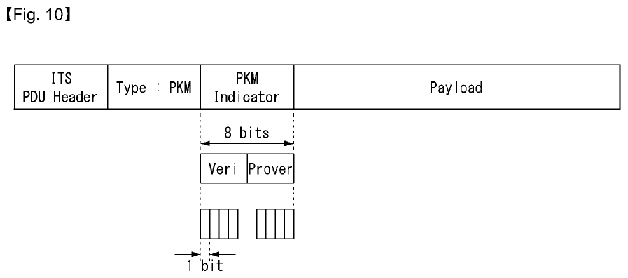

FIG. 10 illustrates a structure of an ITS message including a PKM message according to an embodiment of the disclosure. ITS message may be referred to as a V2X message, V2I message, or X2X message depending on the object that transmits or receives the message.

Referring to FIG. 10, the ITS message may include an ITS PDU header and at least one container. The ITS PDU header may be a common header used in the ITS message and may be present at the head of the ITS message. According to an embodiment, the ITS PDU header may include basic information for the ITS message or V2X communication device. For example, the ITS PDU header may include information for the protocol version, message type, and/or the ID of the sending V2X communication device. The at least one container may include payload data, and the payload data may include, e.g., the data of the PKM message described above in connection with FIG. 9. In the disclosure, the ITS message including the data of each PKM message of FIG. 9 may be denoted by the name of the PKM message. For example, the ITS message including the PKM request message may be denoted a PKM request message, and the ITS message including the data of the PKM initialization message may be denoted a PKM initialization message.

According to an embodiment, the ITS message may include type information indicating the type of the ITS message. In this case, the type information may be included in the ITS PDU header or a separate container other than the ITS PDU header.

According to an embodiment, if the data of the PKM message is included in the payload of the ITS message, the ITS message may include a PKM indicator indicating the object that generates or transmits the PKM message. In this case, the PKM indicator may be included in a separate container other than the ITS PDU header. According to an embodiment, the type information and the PKM indicator may be included in the same container.

According to an embodiment, the PKM indicator may be a 8-bit field and may indicate which one of the verifier and prover generates or transmits the PKM message. For example, if the verifier generates or transmits the PKM message, the first four bits of the PKM indicator may be activated. Or, if the prover generates or transmits the PKM message, the last four bits of the PKM indicator may be activated. The opposite may be considered as well. Thus, the receiver receiving the PKM message-containing ITS message may identify which one has generated or transmitted the PKM message even without parsing the payload data.

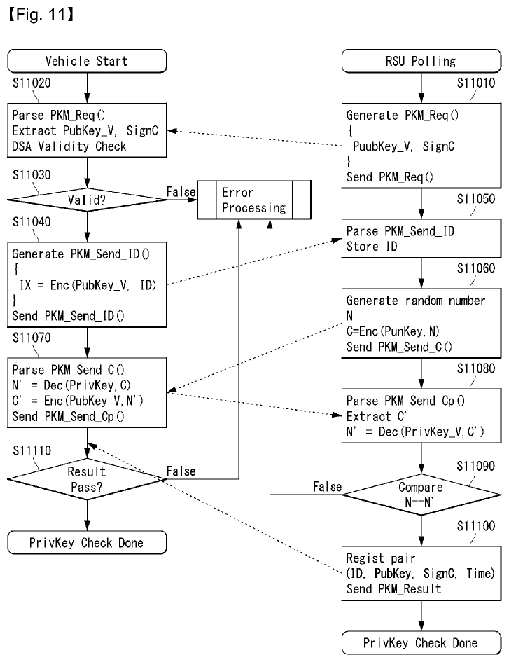

FIG. 11 is a flowchart illustrating a key forgery/falsification inspection procedure performed by a vehicle V2X communication device and an RSU V2X communication device according to an embodiment of the disclosure. In particular, in the embodiment of FIG. 11, a vehicle V2X communication device and an RSU V2X communication device may perform the modification check procedure described above in connection with FIG. 7, performing a modification check on the private key of the vehicle or vehicle V2X communication device. In connection with FIG. 11, what has been described above in connection with FIG. 7 is omitted.

As in the embodiment of FIG. 7, in the embodiment of FIG. 11, the RSU V2X communication device may play a role as the verifier, and the vehicle V2X communication device may play a role as the prover. It is assumed in the embodiment of FIG. 7 that a modification check method/procedure is initiated at the request of the verifier. It is also assumed that the prover's public key (PubKey), signature (Sign), and/or private key (PubKey) are information previously shared with the verifier.

A method for performing a modification check procedure by the vehicle V2X communication device and the RSU V2X communication device is described below with reference to FIG. 11. According to an embodiment, the RSU V2X communication device, as the verifier, may periodically (e.g., every 10 seconds) perform a private key modification check on each vehicle V2X communication device, as the prover.

First, the RSU V2X communication device may generate a PKM request message (PKM_Req) for requesting the vehicle V2X communication device to perform a private key modification check and transmit the PKM request message to the vehicle V2X communication device (S12010). In this case, the PKM request message may include information (e.g., the public key (PubKey_V) and/or signature (SignC) of the RSU V2X communication device) related to the public key of the RSU V2X communication device, as authentication information.

The vehicle V2X communication device may parse the PKM request message, obtain the information related to the public key of the RSU V2X communication device in the PKM request message, and perform a validity check thereon using a preset validity check method/algorithm (e.g., a digital signature algorithm (DSA)) (S11020). By so doing, the vehicle V2X communication device may identify whether the RSU V2X communication device may verify itself, i.e., whether the RSU V2X communication device is a due RSU V2X communication device.

The vehicle V2X communication device may determine whether the information related to the public key of the RSU V2X communication device is valid based on the result of the validity check (S11030). If the information related to the public key of the RSU V2X communication device is invalid (i.e., if the RSU V2X communication device is not a due RSU V2X communication device), error processing may be carried out. Otherwise, if the RSU V2X communication device is valid (i.e., if the RSU V2X communication device is a due RSU V2X communication device), the vehicle V2X communication device may generate a PKM ID message and transmit the PKM ID message (PKM_Send_ID), as responsive to the PKM request message, to the RSU V2X communication device (S11040). In this case, the vehicle V2X communication device may encrypt the ID of the vehicle V2X communication device using the public key (PubKey_V) of the RSU V2X communication device and generate a PKM ID message including information for the encrypted ID (IX).

The RSU V2X communication device may parse the PKM ID message and obtain and store the ID of the vehicle V2X communication device (S11050). In this case, the RSU V2X communication device may obtain the ID of the vehicle V2X communication device by decrypting the encrypted ID (IX) in the PKM ID message using the private key (PrivKey_V) of the RSU V2X communication device.

Meanwhile, according to an embodiment, if the RSU V2X communication device fails to receive the PKM ID message within a preset period (e.g., 20 ms) of transmission of the PKM request message, the modification check procedure may be terminated. As such, setting a timeout period enables the network to be efficiently operated even when many restrictions are imposed on the network as in the DSRC environment.

The RSU V2X communication device may generate a random number (N), encrypt the random number using the public key (PubKey) of the vehicle V2X communication device, and transmit a PKM random number message (PKM_Send_C) including information for the encrypted random number (C) to the vehicle V2X communication device (S11060). As such, the PKM random number message (PKM_Send_C) generated by the RSU V2X communication device may be denoted a first PKM random number message.

Meanwhile, according to an embodiment, if the RSU V2X communication device fails to transmit the first PKM random number message within a preset period (e.g., 50 ms) of reception of the PKM ID message, the modification check procedure may be terminated. As such, setting a timeout period enables the network to be efficiently operated even when many restrictions are imposed on the network as in the DSRC environment.

The vehicle V2X communication device may parse the first PKM random number message, obtain the information for the encrypted random number (C), decrypt the encrypted random number using the private key (PrivKey) of the vehicle V2X communication device, reencrypt the decrypted random number (N′) using the public key (PubKey_V) of the RSU V2X communication device, generate a PKM random number message (PKM_Send_Cp) including information for the reencrypted random number (C′), and transmit the PKM random number message to the RSU V2X communication device (S11070). As such, the PKM random number message (PKM_Send_Cp) generated by the vehicle V2X communication device may be denoted a second PKM random number message.

Meanwhile, according to an embodiment, if the vehicle V2X communication device fails to transmit the second PKM random number message within a preset period (e.g., 50 ms) of reception of the first PKM random number message, the modification check procedure may be terminated. As such, setting a timeout period enables the network to be efficiently operated even when many restrictions are imposed on the network as in the DSRC environment.

The RSU V2X communication device may parse the second PKM random number message, obtain the information for the second encrypted random number (C′), and decrypt the reencrypted random number using the private key (PrivKey_V) of the RSU V2X communication device, thereby obtaining the information for the decrypted random number (N′) (S11080).

The RSU V2X communication device may make comparison as to whether the decrypted random number (N′) is the same as the first random number (N) generated by the RSU V2X communication device (S11090). By doing so, the RSU V2X communication device may determine whether the private key of the vehicle V2X communication device has been forged/falsified.

The RSU V2X communication device may register an information pair including the ID of the vehicle V2X communication device, public key, the signature of the RSU V2X communication device, and/or time information, generate a PKM result message according to the result of comparison, and transmit the PKM result message to the vehicle V2X communication device (S11100). For example, upon determining that the private key of the vehicle V2X communication device has not been forged/falsified, the RSU V2X communication device may transmit a PKM result message including pass information indicating that the private key of the vehicle V2X communication device has not been forged/falsified to the vehicle V2X communication device. Upon determining that the private key of the vehicle V2X communication device has been forged/falsified, the RSU V2X communication device may transmit a PKM result message including fail information indicating that the private key of the vehicle V2X communication device has been forged/falsified to the vehicle V2X communication device.

The vehicle V2X communication device may determine whether the modification check has been passed based on the PKM result message (S11110). For example, upon receiving the PKM result message including the pass message, the vehicle V2X communication device may determine that the modification check has been passed. In this case, the vehicle V2X communication device may perform secure communication with other vehicle V2X communication device. Upon receiving the PKM result message including the fail message, the vehicle V2X communication device may determine that the modification check has not been passed. In this case, an error handling procedure for regenerating and registering its private key/public key may be carried out.

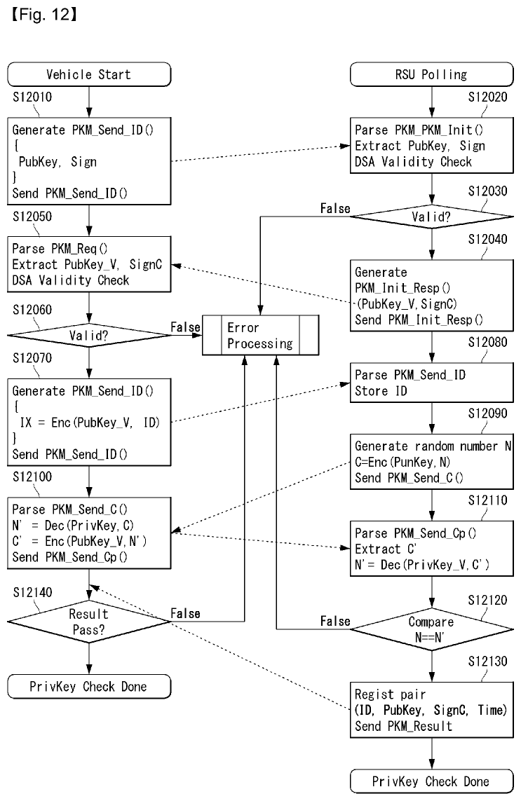

FIG. 12 is a flowchart illustrating a key forgery/falsification inspection procedure performed by a vehicle V2X communication device and an RSU V2X communication device according to another embodiment of the disclosure. In particular, in the embodiment of FIG. 12, a vehicle V2X communication device and an RSU V2X communication device may perform the modification check procedure described above in connection with FIG. 8, performing a modification check on the private key of the vehicle or vehicle V2X communication device. In connection with FIG. 12, what has been described above in connection with FIGS. 7, 8, and 11 is omitted.

As in the embodiment of FIG. 8, in the embodiment of FIG. 12, the RSU V2X communication device may play a role as the verifier, and the vehicle V2X communication device may play a role as the prover. It is assumed in the embodiment of FIG. 7 that a modification check method/procedure is initiated at the request of the verifier. It is also assumed that the prover's public key (PubKey), signature (Sign), and/or private key (PubKey) are information previously shared with the verifier.

A method for performing a modification check procedure by the vehicle V2X communication device and the RSU V2X communication device is described below with reference to FIG. 12.

First, the vehicle V2X communication device may generate a PKM initialization request message (PKM_Init) for requesting the RSU V2X communication device to initialize a private key modification check and transmit the PKM initialization request message to the RSU V2X communication device (S12010). According to an embodiment, the PKM initialization request message may include information (e.g., the public key (PrivKey) and signature (SignC) of the vehicle V2X communication device) related to the public key of the vehicle V2X communication device, as authentication information for the vehicle V2X communication device (first authentication information). The PKM initialization request message may be denoted a PKM initialization message.

The RSU V2X communication device may parse the PKM initialization request message, obtain the information related to the public key of the vehicle V2X communication device in the PKM initialization request message, and perform a validity check thereon using a preset validity check method/algorithm (e.g., a digital signature algorithm (DSA)) (S12020). Thus, the RSU V2X communication device may identify whether the vehicle V2X communication device is a due vehicle V2X communication device or whether the public key of the vehicle V2X communication device is valid.

The vehicle V2X communication device may determine whether the information related to the public key of the RSU V2X communication device is valid based on the result of the validity check (S12030). If the information related to the public key of the vehicle V2X communication device is invalid (e.g., if the public key of the vehicle V2X communication device is invalid), error handling may be performed.

If the information related to the public key of the vehicle V2X communication device is valid (i.e., if the public key of the vehicle V2X communication device is valid), the RSU V2X communication device may generate a PKM initialization response message, which is responsive to the PKM initialization request message, and transmit the PKM initialization response message to the vehicle V2X communication device (S12040). In this case, the PKM initialization response message may include the information (e.g., the public key (PubKey_V) and/or signature (SignC) of the RSU V2X communication device) related to the RSU V2X communication device as authentication information (second authentication information) for the RSU communication device. As such, the PKM initialization response message includes the same information as the PKM request message described above in connection with, e.g., FIGS. 8 and 12 and corresponds to a message used to perform the same function. Thus, the subsequent steps (S12050 to S12130) are identical to the procedure described above in connection with FIG. 12 except that the RSU V2X communication device transmits the PKM initialization response message instead of the PKM request message. This is briefly described below.

First, the vehicle V2X communication device may parse the PKM initialization response message, obtain the information related to the public key of the RSU V2X communication device in the PKM initialization response message, and perform a validity check thereon using a preset validity check method/algorithm (e.g., a digital signature algorithm (DSA)) (S12050). By so doing, the vehicle V2X communication device may identify whether the RSU V2X communication device may verify itself, i.e., whether the RSU V2X communication device is a due RSU V2X communication device.

The vehicle V2X communication device may determine whether the information related to the public key of the RSU V2X communication device is valid based on the result of the validity check (S12060). If the information related to the public key of the RSU V2X communication device is invalid (i.e., if the RSU V2X communication device is not a due RSU V2X communication device), error processing may be carried out. Otherwise, if the RSU V2X communication device is valid (i.e., if the RSU V2X communication device is a due RSU V2X communication device), the vehicle V2X communication device may generate a PKM ID message and transmit the PKM ID message (PKM_Send_ID), as responsive to the PKM request message, to the RSU V2X communication device (S12070). In this case, the vehicle V2X communication device may encrypt the ID of the vehicle V2X communication device using the public key (PubKey_V) of the RSU V2X communication device and generate a PKM ID message including information for the encrypted ID (IX).

The RSU V2X communication device may parse the PKM ID message and obtain and store the ID of the vehicle V2X communication device (S12080). In this case, the RSU V2X communication device may obtain the ID of the vehicle V2X communication device by decrypting the encrypted ID (IX) in the PKM ID message using the private key (PrivKey_V) of the RSU V2X communication device.

Meanwhile, according to an embodiment, if the RSU V2X communication device fails to receive the PKM ID message within a preset period (e.g., 20 ms) of transmission of the PKM request message, the modification check procedure may be terminated. As such, setting a timeout period enables the network to be efficiently operated even when many restrictions are imposed on the network as in the DSRC environment.

The RSU V2X communication device may generate a random number (N), encrypt the random number using the public key (PubKey) of the vehicle V2X communication device, and transmit a PKM random number message (PKM_Send_C) including information for the encrypted random number (C) to the vehicle V2X communication device (S12090). As such, the PKM random number message (PKM_Send_C) generated by the RSU V2X communication device may be denoted a first PKM random number message.

Meanwhile, according to an embodiment, if the RSU V2X communication device fails to transmit the first PKM random number message within a preset period (e.g., 50 ms) of reception of the PKM ID message, the modification check procedure may be terminated. As such, setting a timeout period enables the network to be efficiently operated even when many restrictions are imposed on the network as in the DSRC environment.

The vehicle V2X communication device may parse the first PKM random number message, obtain the information for the encrypted random number (C), decrypt the encrypted random number using the private key (PrivKey) of the vehicle V2X communication device, reencrypt the decrypted random number (N′) using the public key (PubKey_V) of the RSU V2X communication device, generate a PKM random number message (PKM_Send_Cp) including information for the reencrypted random number (C′), and transmit the PKM random number message to the RSU V2X communication device (S12100). As such, the PKM random number message (PKM_Send_Cp) generated by the vehicle V2X communication device may be denoted a second PKM random number message.

Meanwhile, according to an embodiment, if the vehicle V2X communication device fails to transmit the second PKM random number message within a preset period (e.g., 50 ms) of reception of the first PKM random number message, the modification check procedure may be terminated. As such, setting a timeout period enables the network to be efficiently operated even when many restrictions are imposed on the network as in the DSRC environment.

The RSU V2X communication device may parse the second PKM random number message, obtain the information for the second encrypted random number (C′), and decrypt the reencrypted random number using the private key (PrivKey_V) of the RSU V2X communication device, thereby obtaining the information for the decrypted random number (N′) (S12110).

The RSU V2X communication device may make comparison as to whether the decrypted random number (N′) is the same as the first random number (N) generated by the RSU V2X communication device (S12120). By doing so, the RSU V2X communication device may determine whether the private key of the vehicle V2X communication device has been forged/falsified.

The RSU V2X communication device may register an information pair including the ID of the vehicle V2X communication device, public key, the signature of the RSU V2X communication device, and/or time information, generate a PKM result message according to the result of comparison, and transmit the PKM result message to the vehicle V2X communication device (S12130). For example, upon determining that the private key of the vehicle V2X communication device has not been forged/falsified, the RSU V2X communication device may transmit a PKM result message including pass information indicating that the private key of the vehicle V2X communication device has not been forged/falsified to the vehicle V2X communication device. Upon determining that the private key of the vehicle V2X communication device has been forged/falsified, the RSU V2X communication device may transmit a PKM result message including fail information indicating that the private key of the vehicle V2X communication device has been forged/falsified to the vehicle V2X communication device.

The vehicle V2X communication device may determine whether the modification check has been passed based on the PKM result message (S12140). For example, upon receiving the PKM result message including the pass message, the vehicle V2X communication device may determine that the modification check has been passed. In this case, the vehicle V2X communication device may perform secure communication with other vehicle V2X communication device. Upon receiving the PKM result message including the fail message, the vehicle V2X communication device may determine that the modification check has not been passed. In this case, an error handling procedure for regenerating and registering its private key/public key may be carried out.

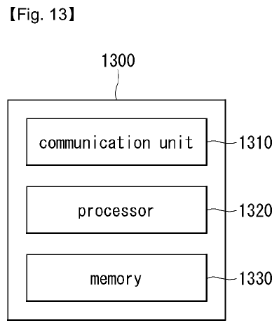

FIG. 13 illustrates a V2X communication device 1300 according to an embodiment of the disclosure.

Referring to FIG. 13, a V2X communication device 1300 may include a memory 1310, a processor 1320, and a communication unit 1330. The V2X communication device 1300 may correspond to an on board unit (OBU) or road side unit (RSU) or may be included in an OBU or RSU. The V2X communication device 1300 may be included in an intelligent transport system (ITS) station or may correspond to an ITS station.

The communication unit 1330 may be connected with the processor 1320 to transmit/receive wireless signals. The communication unit 1330 may up-convert data received from the processor 1320 into a transmission/reception band and transmit the signal. The communication unit 1330 may down-convert a received signal and transfer the signal to the processor 1320. The communication unit 1330 may implement the operation of the access layer. According to an embodiment, the communication unit 1330 may implement the operation of the physical layer included in the access layer or may additionally implement the operation of the MAC layer. The communication unit 1330 may also include a plurality of sub communication units 1330 to perform communication according to a plurality of communication protocols. According to an embodiment, the communication unit 1330 may perform communication based on 802.11, WAVE (Wireless Access in Vehicular Environments), DSRC (Dedicated Short Range Communications), 4G (LTE, Long-Term Evolution), or other various WLAN (Wireless Local Area Network) communication protocols and cellular communication protocols.

The processor 1320 may be connected with the communication unit 1330 to implement the operation of the layers according to the ITS system or WAVE system. The processor 1320 may be configured to perform operations according to various embodiments of the disclosure as described with reference to the drawings. Further, according to various embodiments of the disclosure, at least one of a module, data, program, or software for implementing the operation of the V2X communication device 1300 may be stored in the memory 1310 and be executed by the processor 1320.

The memory 1310 is connected with the processor 1320 to store various pieces of information for driving the processor 1320. The memory 1310 may be included in the processor 1320 or be installed outside the processor 1320 and connected with the processor 1320 via a known means. The memory 1310 may include a secure/non-secure storage device or be included in a secure/non-secure storage device. According to an embodiment, the memory 1310 may be denoted a secure/non-secure storage device.

The specific configuration of the V2X communication device 1300 of FIG. 13 may be implemented so that various embodiments of the disclosure are applied independently from each other or two or more thereof are applied together.

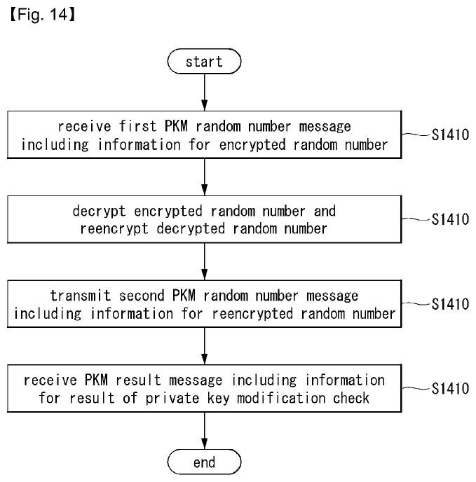

FIG. 14 illustrates a method for performing forgery/falsification inspection on a private key by a V2X communication device according to an embodiment of the disclosure. In the embodiment of FIG. 14, the V2X communication device may be a vehicle V2X communication device, and the external V2X communication device may be an RSU V2X communication device.

First, the V2X communication device may receive a first private key modification (PKM) random number message including information for an encrypted random number from the external V2X communication device (S1410). According to an embodiment, the encrypted random number may be generated by encrypting a random number generated by the external V2X communication device using the public key of the V2X communication device. In this case, the random number and the encrypted random number may be generated by the external V2X communication device as set forth above.

The V2X communication device may decrypt the encrypted random number using the private key of the V2X communication device and may reencrypt the decrypted random number using the public key of the external V2X communication device (S1420).

The V2X communication device may transmit a second PKM random number message including information for the reencrypted random number to the external V2X communication device (S1430).

The V2X communication device may receive a PKM result message including information for the result of a modification check on the private key of the V2X communication device from the external V2X communication device (S1440). According to an embodiment, the modification check result information may be generated based on a result of comparison between the random number generated by the external V2X communication device and the random number generated by decrypting the random number reencrypted using the private key of the external V2X communication device.

The key modification check procedure of the steps S1410 to S1440 is the same as what has been described above in connection with FIGS. 7, 8, 11, and 12.

According to an embodiment, before the step of receiving the first PKM random number message, the V2X communication device may further include the step of transmitting a PKM initialization message for initializing the modification check on the private key of the V2X communication device to the external V2X communication device and the step of receiving a PKM initialization response message, which is responsive to the PKM initialization message, from the external V2X communication device. According to an embodiment, the PKM initialization message may include first authentication information for authenticating the V2X communication device, and the PKM initialization response message may include second authentication information for authenticating the external V2X communication device. Further, the V2X communication device may further include the step of authenticating the external V2X communication device using the second authentication information. Such an initialization procedure is the same as what has been described above in connection with FIGS. 9 and 13.

According to an embodiment, before the step of receiving the first PKM random number message, the V2X communication device may further include the step of receiving a PKM request message for requesting a modification check on the private key of the V2X communication device from the external V2X communication device. According to an embodiment, the PKM request message may include second authentication information for authenticating the external V2X communication device. Further, the V2X communication device may further include the step of authenticating the external V2X communication device using the second authentication information. Such an authentication procedure is the same as what has been described above in connection with FIGS. 8 and 12.

According to an embodiment, the first authentication information may include first public key information, which is information for the public key of the V2X communication device, and first signature information, which is information for a signature generated using the private key of the V2X communication device. The second authentication information may include second public key information, which is information for the public key of the external V2X communication device, and second signature information, which is information for a signature generated using the private key of the external V2X communication device.

According to an embodiment, in the step of receiving the PKM request message, the PKM request message may be periodically received from the external communication device.

According to an embodiment, if the V2X communication device fails to transmit a second PKM random number message within a preset period of the reception of the first PKM random number message, a predefined error handling procedure may be carried out.

The above-described embodiments regard predetermined combinations of the components and features of the disclosure. Each component or feature should be considered as optional unless explicitly mentioned otherwise. Each component or feature may be practiced in such a manner as not to be combined with other components or features. Further, some components and/or features may be combined together to configure an embodiment of the disclosure. The order of the operations described in connection with the embodiments of the disclosure may be varied. Some components or features in an embodiment may be included in another embodiment or may be replaced with corresponding components or features of the other embodiment. It is obvious that the claims may be combined to constitute an embodiment unless explicitly stated otherwise or such combinations may be added in new claims by an amendment after filing.

The embodiments of the disclosure may be implemented by various means, e.g., hardware, firmware, software, or a combination thereof. When implemented in hardware, an embodiment of the disclosure may be implemented with, e.g., one or more application specific integrated circuits (ASICs), digital signal processors (DSPs), digital signal processing devices (DSPDs), programmable logic devices (PLDs), field programmable gate arrays (FPGAs), processors, controllers, micro-controllers, or micro-processors.

When implemented in firmware or hardware, an embodiment of the disclosure may be implemented as a module, procedure, or function performing the above-described functions or operations. The software code may be stored in a memory and driven by a processor. The memory may be positioned inside or outside the processor to exchange data with the processor by various known means.

It is apparent to one of ordinary skill in the art that the disclosure may be embodied in other specific forms without departing from the essential features of the disclosure. Thus, the above description should be interpreted not as limiting in all aspects but as exemplary. The scope of the present disclosure should be determined by reasonable interpretations of the appended claims and all equivalents of the present disclosure belong to the scope of the present disclosure.

### Mode for Practicing the Disclosure

It is appreciated by one of ordinary skill in the art that various changes and modifications may be made to the embodiments of the disclosure without departing from the scope or spirit of the disclosure. Thus, all such changes or modifications are intended to belong to the scope of the disclosure as defined by the appended claims or equivalents thereof.

The disclosure sets forth both devices and methods, and descriptions thereof may be complementarily applicable to each other.

Various embodiments have been described in the best mode for practicing the disclosure.

### INDUSTRIAL AVAILABILITY

In the disclosure, a series of smart car/connected car fields or V2X communication fields may be used.

It is appreciated by one of ordinary skill in the art that various changes and modifications may be made to the embodiments of the disclosure without departing from the scope or spirit of the disclosure. Thus, all such changes or modifications are intended to belong to the scope of the disclosure as defined by the appended claims or equivalents thereof.

1. A method for a modification check on a private key of a V2X communication device, the method comprising:
receiving a first private key modification (PKM) random number message including information for an encrypted random number from an external V2X communication device, the encrypted random number generated by encrypting a random number generated by the external V2X communication device using a public key of the V2X communication device;
decrypting the encrypted random number using the private key of the V2X communication device and reencrypting the decrypted random number using a public key of the external V2X communication device;
transmitting a second PKM random number message including information for the reencrypted random number to the external V2X communication device; and
receiving a PKM result message including information for a result of the modification check on the private key of the V2X communication device from the external V2X communication device, wherein the modification check result information is generated based on a result of comparison between the random number generated by the external V2X communication device and a random number generated by decrypting the reencrypted random number using a private key of the external V2X communication device.

2. The method of claim 1, further comprising: before receiving the first PKM random number message,
transmitting a PKM initialization message for initializing the modification check on the private key of the V2X communication device to the external V2X communication device, the PKM initialization message including first authentication information for authenticating the V2X communication device;
receiving, from the external V2X communication device, a PKM initialization response message responsive to the PKM initialization message, the PKM initialization response message including second authentication information for authenticating the external V2X communication device; and
authenticating the external V2X communication device using the second authentication information.

3. The method of claim 1, further comprising: before receiving the first PKM random number message,
receiving, from the external V2X communication device, a PKM request message for requesting the modification check on the private key of the V2X communication device, the PKM request message including second authentication information for authenticating the external V2X communication device; and
authenticating the external V2X communication device using the second authentication information.

4. The method of claim 2, wherein
the first authentication information includes first public key information which is information for the public key of the V2X communication device and first signature information which is information for a signature generated using the private key of the V2X communication device, and
the second authentication information includes second public key information which is information for the public key of the external V2X communication device and second signature information which is information for a signature generated using the private key of the external V2X communication device.

5. The method of claim 3, wherein
receiving the PKM request message includes periodically receiving the PKM request message from the external communication device.

6. The method of claim 1, wherein
if the V2X communication device fails to transmit the second PKM random number message within a preset period of the reception of the first PKM random number message, a predefined error handling procedure is performed.

7. The method of claim 1, wherein
the V2X communication device is a vehicle V2X communication device, and the external V2X communication device is a road side unit (RSU) V2X communication device.

8. A V2X communication device performing a private key modification check, the V2X communication device comprising:
a secure/non-secure storage device storing data;
an RF unit transmitting/receiving a wireless signal; and
a processor controlling the RF unit, wherein
the processor:
receives a first private key modification (PKM) random number message including information for an encrypted random number from an external V2X communication device, the encrypted random number generated by encrypting a random number generated by the external V2X communication device using a public key of the V2X communication device;
decrypts the encrypted random number using the private key of the V2X communication device and reencrypting the decrypted random number using a public key of the external V2X communication device;
transmits a second PKM random number message including information for the reencrypted random number to the external V2X communication device; and
receives a PKM result message including information for a result of the modification check on the private key of the V2X communication device from the external V2X communication device, wherein the modification check result information is generated based on a result of comparison between the random number generated by the external V2X communication device and a random number generated by decrypting the reencrypted random number using a private key of the external V2X communication device.

9. The V2X communication device of claim 8, wherein the processor:
transmits a PKM initialization message for initializing the modification check on the private key of the V2X communication device to the external V2X communication device, the PKM initialization message including first authentication information for authenticating the V2X communication device;
receives, from the external V2X communication device, a PKM initialization response message responsive to the PKM initialization message, the PKM initialization response message including second authentication information for authenticating the external V2X communication device; and
authenticates the external V2X communication device using the second authentication information.

10. The V2X communication device of claim 9, wherein the processor:
receives, from the external V2X communication device, a PKM request message for requesting the modification check on the private key of the V2X communication device, the PKM request message including second authentication information for authenticating the external V2X communication device; and
authenticates the external V2X communication device using the second authentication information.

11. The V2X communication device of claim 9, wherein
the first authentication information includes first public key information which is information for the public key of the V2X communication device and first signature information which is information for a signature generated using the private key of the V2X communication device, and
the second authentication information includes second public key information which is information for the public key of the external V2X communication device and second signature information which is information for a signature generated using the private key of the external V2X communication device.

12. The V2X communication device of claim 10, wherein
receiving the PKM request message includes periodically receiving the PKM request message from the external communication device.

13. The V2X communication device of claim 8, wherein
if the V2X communication device fails to transmit the second PKM random number message within a preset period of the reception of the first PKM random number message, a predefined error handling procedure is performed.

14. The V2X communication device of claim 8, wherein
the V2X communication device is a vehicle V2X communication device, and the external V2X communication device is a road side unit (RSU) V2X communication device.
